(19) United States
(12) Patent Application Publication
(10) Pub. No.: US 2014/0368644 A1
(43) Pub. Date: Dec. 18, 2014

(54) APPARATUS AND METHOD FOR TRACKING DRIVER ATTENTIVENESS USING VECTOR

(71) Applicant: Hyundai Motor Company, Seoul (KR)

(72) Inventors: Dong Hee Seok, Seoul (KR); Seok Beom Lee, Seoul (KR)

(73) Assignee: HYUNDAI MOTOR COMPANY, Seoul (KR)

(21) Appl. No.: 14/078,894

(22) Filed: Nov. 13, 2013

(30) Foreign Application Priority Data
Jun. 13, 2013 (KR) 10-2013-0067998

(51) Int. Cl. H04N 7/18

(52) U.S. Cl. CPC H04N 7/18
USPC 348/143

(57) ABSTRACT

An apparatus and a method for tracking driver attentiveness using a vector are provided. The apparatus includes an imaging device that detects a driver's attentiveness and a controller that is configured to set an initial attentiveness area of the driver based on a motion of the driver's attentiveness detected by the imaging device. In addition, the controller is configured to set a current attentiveness area of the driver by calculating a vector value based on a change of the driver's attentiveness and set an inflection point based on the current attentiveness area.

### CROSS-REFERENCE TO RELATED APPLICATION

This application claims the benefit under 35 U.S.C. §119(a) of a Korean patent application filed in the Korean Intellectual Property Office on Jun. 13, 2013 and assigned Serial No. 2013-0067998, and the entire disclosure of which is hereby incorporated by reference

### BACKGROUND

1. Field of the Invention

The present invention relates to an apparatus and a method for tracking driver attentiveness using a vector, and more particularly, to an apparatus and a method for tracking driver attentiveness using a vector that sets an initial attentiveness area of a driver based on a driver's attentiveness and resets the attentiveness area of the driver using a vector value based on a change in the driver's attentiveness.

2. Description of the Related Art

Generally, as a driving auxiliary means of a vehicle, a technology using an attentiveness vector of a driver has been continuously developed. In particular, a technology that detects the attentiveness vector for each of the driver's right and left eyes is mainly used. The attentiveness vector for each of the right and left eyes may recognize that the yes are horizontally positioned on a target object and a horizontal component of the attentiveness vector may be relatively accurately confirmed, but a vertical component of the attentiveness vector may be difficult to recognize accurately. Therefore, in confirming an attentiveness position of the driver, precision may be degraded and substantial time may be consumed as the attentiveness vector for each of right and left eyes needs to be detect.

In addition, the technology of confirming the attentiveness position of the driver may be applied to an attentiveness recognition computer for a handicapped person as well as the driving auxiliary means of the vehicle, such that a need exists for the improvement of speed and precision of the technology of confirming the attentiveness position of a user.

### SUMMARY

The present invention provides an apparatus and a method for tracking driver attentiveness using a vector that sets an initial attentiveness area of a driver based on a driver's attentiveness and, when a vector value based on a change in the driver's attentiveness exceeds a predetermined threshold, the attentiveness area of the driver may be reset using the vector value.

In accordance with an aspect of the present invention, an apparatus for tracking driver attentiveness using a vector may include: a camera configured to detect a driver's attentiveness; and a controller configured to set an initial attentiveness area of the driver based on a motion of the driver's attentiveness detected by the camera, set a current attentiveness area of the driver by calculating a vector value based on a change of the driver's attentiveness, and set an inflection point based on the current attentiveness area. The controller may be configured to set an area in which the vector value is a predetermined threshold as the initial attentiveness area based on a specific point for the driver's attentiveness. The controller may be configured to set the current attentiveness area of the driver by adding each of the vector values when each of the vector values of the current attentiveness and the previous attentiveness of the driver exceeds the predetermined threshold. Further, the controller may be configured to set the current attentiveness area of the driver by calculating an average value of each of the vector values when each of the vector values of the current attentiveness and the previous attentiveness of the driver does not exceed the predetermined threshold. The controller may be configured to set an inflection point based on the current attentiveness area when the motion of the driver's attentiveness is detected after the current attentiveness area is set.

In accordance with another aspect of the present invention, a method for tracking of attentiveness using a vector may include: receiving, by a controller, image data for a driver's attentiveness detected by a camera in real time; setting, by the controller, an initial attentiveness area of a driver based on a motion of the driver's attentiveness by analyzing the image data; calculating, by the controller, a vector value based on a change of the driver's attentiveness; setting, by the controller, a current attentiveness area of the driver using the calculated vector value; and setting, by the controller, an inflection point based on the set current attentiveness area.

Further, setting an initial attentiveness area of a driver may include setting an area in which the vector value is a predetermined threshold as the initial attentiveness area based on a specific point for the driver's attentiveness. In addition, calculating a vector value may include confirming a vector value of the current attentiveness of the driver and a vector value of the previous attentiveness; comparing each of the vector values with the predetermined threshold; and adding each of the vector values when each of the vector values exceeds the predetermined threshold, and calculating an average value of each of the vector values when each of the vector values does not exceed the predetermined threshold. Furthermore, setting an inflection point based on the set current attentiveness area may include setting the inflection point based on the current attentiveness area when the motion of the driver's attentiveness is detected after the current attentiveness area is set.

### BRIEF DESCRIPTION OF THE DRAWINGS

The objects, features and advantages of the present invention will be more apparent from the following detailed description in conjunction with the accompanying drawings, in which:

FIG. 1 is an exemplary block diagram illustrating a main configuration of an apparatus for tracking driver attentiveness using a vector according to an exemplary embodiment of the present invention;

FIG. 2 is an exemplary diagram illustrating a method for tracking driver attentiveness using a vector according to an exemplary embodiment of the present invention; and

FIG. 3 is an exemplary flow chart describing a method for tracking driver attentiveness using a vector according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

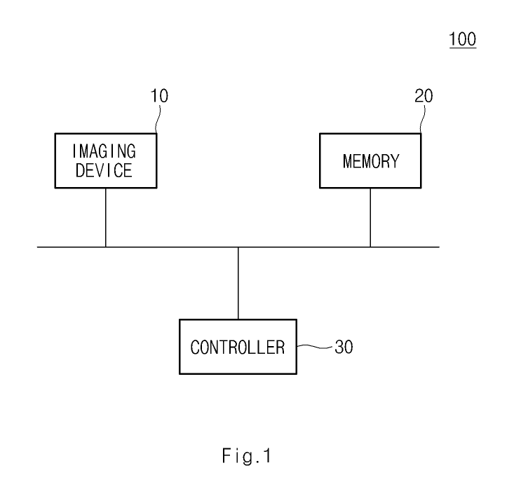

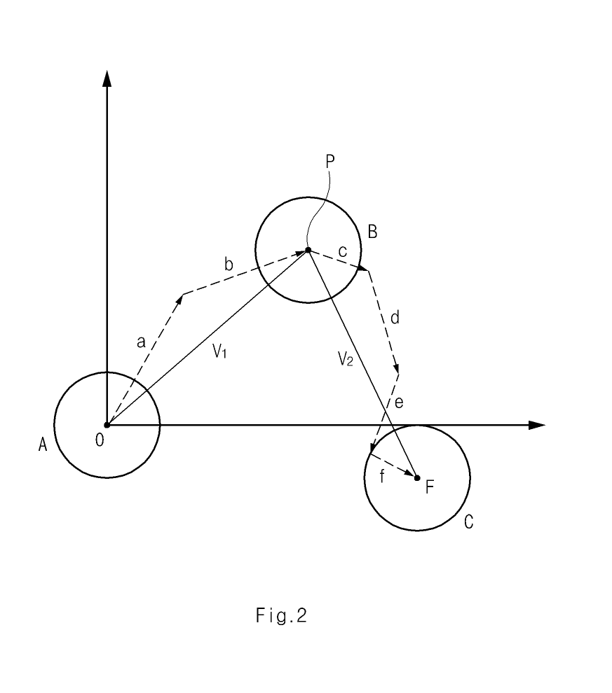

FIG. 1 is an exemplary block diagram illustrating a main configuration of an apparatus for tracking driver attentiveness using a vector according to an exemplary embodiment of the present invention. FIG. 2 is an exemplary diagram illustrating a method for tracking driver attentiveness using a vector according to an exemplary embodiment of the present invention.

Referring to FIGS. 1 to 2, an apparatus for tracking driver attentiveness using a vector (hereinafter referred to as a tracking apparatus 100) according to the exemplary embodiment of the present invention may include an imaging device (e.g., a camera) 10, a memory 20, and controller 30.

The imaging device 10 may be a camera configured to detect a driver's attentiveness. In addition, the imaging device 10 may be configured to capture motion of a direction of a face, iris, pupil, and the like of the driver, and may be configured to provide a captured image data to the controller 30. Further, controller 30 may be configured to store the image data obtained from the camera 10 in the memory 20, and a program for calculating a vector value according to an attentiveness position of the driver and various programs for operating a tracking apparatus 100 may be stored in the memory 20.

Moreover, the controller 30 may be configured to set an initial attentiveness area of the driver based on a motion of the driver's attentiveness detected by the imaging device 10, set a current attentiveness area of the driver by calculating the vector value based on a change in the driver's attentiveness, and set an inflection point based on the current attentiveness area. In particular, the controller 30 may be configured to analyze the image data provided from the imaging device 10 in real time to thereby confirm the initial attentiveness area of the driver based on the motion of the driver's attentiveness included to the image data. Further, the controller 30 may be configured to set the initial attentiveness as a starting point (0), and set the attentiveness area that corresponds to the vector value of the predetermined threshold based on the starting point as the initial attentiveness area. The initial attentiveness area may be indicated as reference numeral A of FIG. 2.

In FIG. 2, each of the reference numerals O, P and F indicate the position where the driver's attentiveness is fixed and each of the reference numerals A, B and C indicate the attentiveness area that corresponds to the vector value of the predetermined threshold based on the position where the driver's attentiveness is fixed. In addition, each of the reference numerals a and b indicate a vector value for the attentiveness swept at the time of moving from 0 to P before the driver's attentiveness is fixed at P, and each of the reference numerals c to f indicate a vector value for the attentiveness swept at the time of moving from P to F before the driver's attentiveness is fixed at F.

Referring to FIG. 2, the controller 30 may be configured to set the initial attentiveness area A in which the vector value is the predetermined threshold based on the starting point 0.

The controller 30 may be configured to recognize that the attentiveness point of the driver has changed and may be configured to compare the vector value a and b to the predetermined threshold and the driver's attentiveness to the predetermined threshold, when the driver's attentiveness has deviated from the initial attentiveness area A in which the vector value is set as the predetermined threshold and remain at a specific point P for a certain time or more, through the constant analysis of the image data.

In particular, b may be the vector value for the current attentiveness and a may be the vector value for a previous attentiveness, based on the specific point P. As a result of comparison, when both a and b are greater than the predetermined threshold, the controller 30 may be configured to calculate the vector value V1 from the starting point 0 to the specific point P as the sum of a and b. The controller 30 may be configured to determine the specific point P as the attentiveness point P of the driver. Further, when both a and b are less than the predetermined threshold, the controller 30 may be configured to calculate the vector value V1 as an average value of a and b to determine the specific point P as the attentiveness point P of the driver. Then, the controller 30 may be configured to set a first attentiveness area B in which the vector value is the predetermined threshold based on the attentiveness point P.

Furthermore, the controller 30 may be configured to recognize that the attentiveness point of the driver has changed and may be configured to set the specific point P of the first attentiveness area B as an inflection point P, when the driver's attentiveness has deviated from the first attentiveness area B and remains at a specific point F for a certain time or more. Additionally, the controller 30 may be configured to calculate the vector value V2 from P to F to decide the specific point F as the current attentiveness point F and may be configured to determine the inflection point P as the previous attentiveness point. The controller may be configured to set a second attentiveness area C in which the vector value is the predetermined threshold, that is, the current attentiveness area based on the current attentiveness point F. As a result, the first attentiveness area B may be reset as the previous attentiveness area. The controller 30 may be configured to continuously maintain a directivity of the vector through an addition operation of sum vector of c and d and new-input e and the addition operation of the sum vector through the above addition operation and new-input f, to filter a noise attentiveness. In addition, the controller 30 may be configured to continuously maintain the directivity of the vector by an average operation as well as the addition operation.

As described above, the controller 30 may not be configured to determine that the attentiveness point of the driver has changed when the driver's attentiveness does not deviate from the attentiveness area. Therefore, when a change of the driver's attentiveness is generated in the attentiveness area as a result of the analysis of the image data, the driver's attentiveness may not be tracked, such that an unnecessary operation may be minimized when tracking the driver's attentiveness.

In addition, when the attentiveness deviating from the attentiveness area is continuously changed, the controller 30 may be configured to recognize even a rapidly changing driver, that is, a substantially short attentiveness of the user by using an inflection point scheme, to track the user's attentiveness more accurately and more rapidly. In particular, the present invention may be applied to an attentiveness recognition computer for a handicapped person as well as the driving auxiliary apparatus of a vehicle, thereby confirming the attentiveness position of the user more accurately and more rapidly.

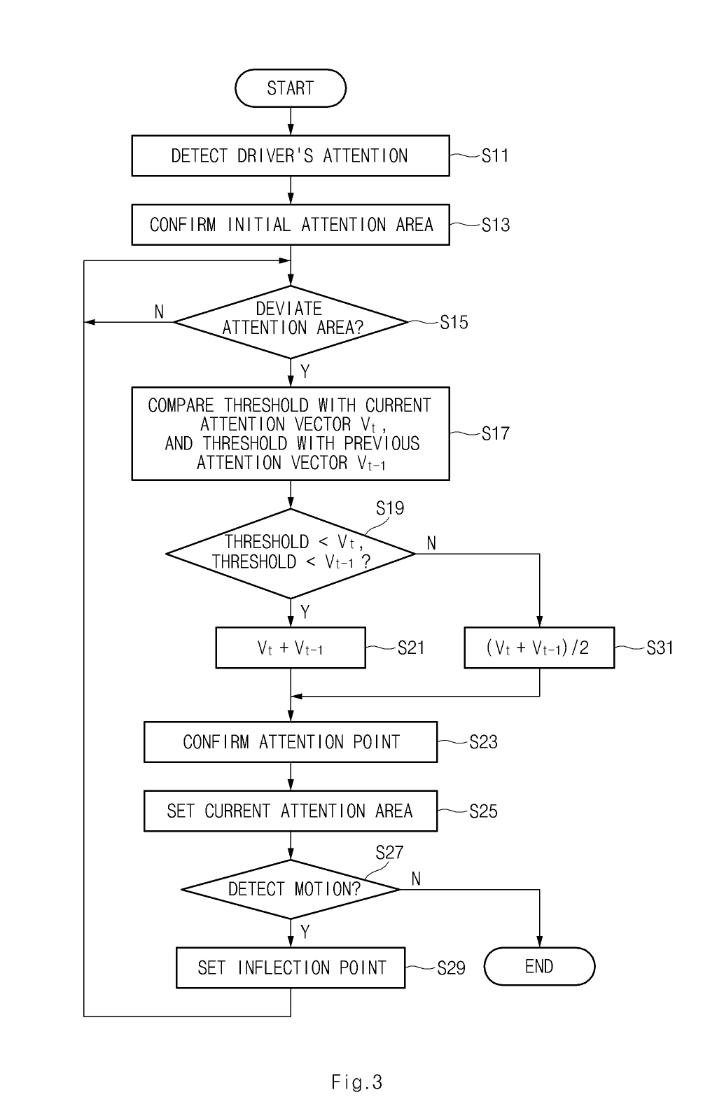

FIG. 3 is an exemplary flow chart describing a method for tracking of attentiveness using a vector according to an exemplary embodiment of the present invention. Referring to FIG. 3, at step S11, the controller 30 may be configured to detect the driver's attentiveness by analyzing the image data obtained from the imaging device 10. At step S13, the controller 30 may be configured to set a certain point in which the driver's attentiveness is fixed for a certain time or more as the initial attentiveness position. The controller 30 may be configured to set an area that has the vector value of the predetermined threshold based on the initial attentiveness position as the initial attentiveness area.

At step S15, the controller 30 may be configured to determine whether the driver's attentiveness deviates from the initial attentiveness area through the constant analysis of the image data. As a result of confirmation at step S15, when the driver's attentiveness deviates from the initial attentiveness area, the controller 30 may proceed to step S17 and when the driver's attentiveness exists in the initial attentiveness area, the controller 30 may be configured to determine whether the driver's attentiveness deviates from the initial attentiveness area by continuously performing step S15.

At step S17, the controller 30 may be configured to determine the specific position in which the driver's attentiveness deviated from the initial attentiveness area is fixed, and may be configured to determine the vector value Vₜ for the current attentiveness swept when moving the attentiveness to the specific position and the vector value Vₜ₋₁ for the previous attentiveness. The controller 30 may be configured to compare the vector value for the confirmed current attentiveness and the vector value for the previous attentiveness with the predetermined threshold respectively.

At step S19, as a result of comparison, when the vector value for the current attentiveness is greater than the predetermined threshold and the vector value for the previous attentiveness is greater than the predetermined threshold, the controller 30 may proceed to step S21. When the vector value for the current attentiveness is less than the predetermined threshold and the vector value for the previous attentiveness is less than the predetermined threshold, the controller 30 may proceed to step S31.

At step S21, the controller 30 may be configured to calculate the sum vector of the vector value for the current attentiveness and the vector value for the previous attentiveness to proceed to step S23, and at step S31, the controller 30 may be configured to calculate the average vector of the vector value for the current attentiveness and the vector value for the previous attentiveness to proceed to step S23. In addition, at step S23, the controller 30 may be configured to determine the specific position confirmed at step S17 as the attentiveness point of the driver and then proceed to step S25 to set the current attentiveness area having the vector value of the predetermined threshold based on the attentiveness point.

At step S27, in response to determining that a motion of the driver's attentiveness is detected, the controller 30 may proceed to step S29. Further. at step S29, after the controller 30 sets the current attentiveness area set at step S25 as the previous attentiveness area and set the attentiveness point as the inflection point, the controller 30 may repeat the above steps by returning to step S15.

As set forth above, the exemplary embodiment of the present invention may set the initial attentiveness area of the driver based on the driver's attentiveness and, when the vector value based on a change in the driver's attentiveness exceeds the predetermined threshold, may reset the attentiveness area of the driver using the vector value, thereby making it possible to minimize an error and a confirming time of the attentiveness point.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the accompanying claims.

What is claimed is:

1. An apparatus for tracking driver attentiveness using a vector, comprising:
an imaging device configured to detect a driver's attentiveness;
a controller having processor coupled to the network interfaces and adapted to execute one or more processes; and
a memory configured to store a process executable by the processor, the process when executed operable to:
set an initial attentiveness area of the driver based on a motion of the driver's attentiveness detected by the imaging device;
set a current attentiveness area of the driver by calculating a vector value based on a change of the driver's attentiveness; and
set an inflection point based on the current attentiveness area.

2. The apparatus of claim 1, wherein the process when executed is further operable to:
set an area in which the vector value is a predetermined threshold as the initial attentiveness area based on a specific point for the driver's attentiveness.

3. The apparatus of claim 2, wherein the process when executed is further operable to:
set the current attentiveness area of the driver by adding each of the vector values when each of the vector values of the current attentiveness and the previous attentiveness of the driver exceeds the predetermined threshold.

4. The apparatus of claim 3, wherein the process when executed is further operable to:
set the current attentiveness area of the driver by calculating an average value of each of the vector values when each of the vector values of the current attentiveness and the previous attentiveness of the driver is less than the predetermined threshold.

5. The apparatus of claim 1, wherein the process when executed is further operable to:
set an inflection point based on the current attentiveness area when the motion of the driver's attentiveness is detected after the current attentiveness area is set.

6. A method for tracking driver attentiveness using a vector, the method comprising:
receiving, by a controller, image data for a driver's attentiveness detected by an imaging device in real time;
setting, by the controller, an initial attentiveness area of a driver based on a motion of the driver's attentiveness by analyzing the image data;
calculating, by the controller, a vector value based on a change of the driver's attentiveness;
setting, by the controller, a current attentiveness area of the driver using the calculated vector value; and
setting, by the controller, an inflection point based on the set current attentiveness area.

7. The method of claim 6, wherein setting an initial attentiveness area of a driver includes:
setting, by the controller, an area in which the vector value is a predetermined threshold as the initial attentiveness area based on a specific point for the driver's attentiveness.

8. The method of claim 7, wherein calculating a vector value includes:
determining, by the controller, a vector value of the current attentiveness of the driver and a vector value of the previous attentiveness;
comparing, by the controller, each of the vector values with the predetermined threshold;
adding, by the controller, each of the vector values when each of the vector values exceeds the predetermined threshold; and
calculating, by the controller, an average value of each of the vector values when each of the vector values is less than the predetermined threshold.

9. The method of claim 7, wherein setting an inflection point based on the set current attentiveness area includes:
setting, by the controller, the inflection point based on the current attentiveness area when the motion of the driver's attentiveness is detected after the current attentiveness area is set.

10. A non-transitory computer readable medium containing program instructions executed by a controller, the computer readable medium comprising:
program instructions that receive image data for a driver's attentiveness detected by an imaging device in real time;
program instructions that set an initial attentiveness area of a driver based on a motion of the driver's attentiveness by analyzing the image data;
program instructions that calculate a vector value based on a change of the driver's attentiveness;
program instructions that set a current attentiveness area of the driver using the calculated vector value; and
program instructions that set an inflection point based on the set current attentiveness area.

11. The non-transitory computer readable medium of claim 10, further comprising:
program instructions that set an area in which the vector value is a predetermined threshold as the initial attentiveness area based on a specific point for the driver's attentiveness.

12. The non-transitory computer readable medium of claim 11, further comprising:
program instructions that determine a vector value of the current attentiveness of the driver and a vector value of the previous attentiveness;
program instructions that compare each of the vector values with the predetermined threshold;
program instructions that add each of the vector values when each of the vector values exceeds the predetermined threshold; and
program instructions that calculate an average value of each of the vector values when each of the vector values is less than the predetermined threshold.

13. The non-transitory computer readable medium of claim 11, further comprising:
program instructions that set the inflection point based on the current attentiveness area when the motion of the driver's attentiveness is detected after the current attentiveness area is set.
